(19) United States
(12) Patent Application Publication
(10) Pub. No.: US 2020/0288721 A1
(43) Pub. Date: Sep. 17, 2020

(54) PESTICIDAL COMPOSITION COMPRISING AN OXIME CARBAMATE AND USE THEREOF

(71) Applicant: JIANGSU ROTAM CHEMISTRY CO., LTD, Jiangsu (CN)

(72) Inventor: James Timothy BRISTOW, Chai Wan (HK)

(21) Appl. No.: 16/649,050

(22) PCT Filed: Sep. 18, 2018
(86) PCT No.: PCT/CN2018/106126

§ 371 Date: Mar. 19, 2020

(30) Foreign Application Priority Data
Sep. 20, 2017 (GB) 1715198.6

(51) Int. Cl. A01N 47/48; A01N 43/28; A01N 25/02; A01N 37/06; A01N 31/02

(52) U.S. Cl. CPC A01N 47/48; A01N 43/28; A01N 31/02; A01N 37/06; A01N 25/02

(57) ABSTRACT

A soluble liquid concentrate (SL) composition is provided. The composition comprising:
i) an oxime carbamate;
ii) a carboxylic acid stabiliser;
and iii) a liquid carrier.

### CROSS REFERENCE TO RELATED APPLICATIONS

This application claims the priority of GB Patent Application No. 1715198.6, filed on Sep. 20, 2017, and titled with “PESTICIDAL COMPOSITION COMPRISING AN OXIME CARBAMATE AND THE USE THEREOF”, and the disclosures of which are hereby incorporated by reference.

### FIELD

The present invention relates to a pesticidal composition comprising an oxime carbamate, in particular to a pesticidal composition exhibiting improved stability of the oxime carbamate active ingredient. The present invention further relates to methods for treating pest infestations and to the use of the pesticidal composition.

### BACKGROUND

Oxime carbamates are a known class of pesticidally active compounds. They are known to exhibit activity as insecticides, acaricides and miticides. Their use in the control of pest infestations in plants, in particular crop plants, is known in the art. Pesticidal formulations comprising oxime carbamates are commercially available.

For example, methyl 2-(dimethylamino)-N-[[(methylamino)carbonyl]oxy]-2-oxoethanimidothioate is an oxime carbamate compound having the common name oxamyl and having the following structure:

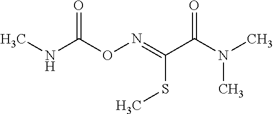

Oxamyl may be prepared using techniques disclosed in U.S. Pat. Nos. 3,576,834, 3,639,633 and 3,530,220. Oxamyl is known to be active as an acaricide, an insecticide and a nematicide. Formulations comprising oxamyl as the active ingredient are known in the art and are available commercially. For example, Vydate® 10G is a commercial granule formulation available from E.I. DuPont de Nemours containing 10% by weight oxamyl. Vydate® L is a liquid concentrate formulation comprising 24% by weight oxamyl.

EP 0 025 255 discloses an insecticidal or nematicidal composition comprising particles of an inert carrier, oxamyl and a barrier material, the barrier material capable of providing a controlled release of oxamyl in water.

US 2008/0287534 concerns the control of foliar insect pests using a mixture of oxamyl with methyl N-[[(methylamino)carbonyl]oxy]ethanimidothioate (methomyl). Oxamyl and methomyl may be applied together or separately. Suitable formulations include compositions comprising a least one liquid diluent, a solid diluent or a surfactant.

US 2005/0096224 discloses a method for controlling invertebrate pests and/or fungal diseases affecting potatoes and other crops. The method employs a range of active ingredients, in particular oxamyl. The active ingredients may be applied in a range of formulations, including liquid formulations comprising a diluent. Suitable liquid diluents are indicated in US 2005/0096224 as being water, N,N-dimethylformamide, dimethyl sulfoxide, N-alkylpyrrolidone, ethylene glycol, polypropylene glycol, propylene carbonate, dibasic esters, paraffins, alkylbenzenes, alkylnaphthalenes, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, and alcohols such as methanol, cyclohexanol, decanol, benzyl and tetrahydrofurfuryl alcohol. A liquid formulation comprising oxamyl, citric acid as a buffer, dyes, sucrose and water as the sole diluent is specifically exemplified in US 2005/0096224.

Insecticidal compositions having high concentrations of active ingredients are disclosed in U.S. Pat. No. 4,481,215. The compositions comprise carbamate insecticides as active ingredients, in particular methomyl. Other carbamate insecticides include oxamyl and aldicarb. The compositions of U.S. Pat. No. 4,481,215 are prepared by reacting the carbamate insecticide with formaldehyde or paraformaldehyde in the presence of a very limited amount of water and a base. In one embodiment of U.S. Pat. No. 4,4 81,215 oxamyl was combined with paraformaldehyde in water and treated with aqueous sodium hydroxide while heating at 45° C. for one hour. The pH of the mixture was then adjusted to 6.7 with acetic acid. Excess formaldehyde was removed by the addition of urea.

U.S. Pat. No. 4,032,654 discloses water-soluble liquid concentrates of methomyl and oxamyl dissolved in designated solvents at a pH of about 2.8 to 3.2. Higher amounts of methomyl and oxamyl are said to be dissolved, compared with the total amount of these compounds that can be dissolved separately. Solvent systems disclosed in U.S. Pat. No. 4,032,654 are methanol/water, acetone/water, and cyclohexanone/cyclohexanol/ methanol/water. The pH of from 2.8 to 3.2 is achieved using an acid, in particular acetic acid, citric acid, sulphuric acid and, most preferably phosphoric acid.

The decomposition of oxamyl in soil and in water is discussed by Harvey, J., et al., ‘Decomposition of Oxamyl in Soil and Water’, J. Agric. Food Chem., Vol. 26, No. 3, 1978, pages 536 to 541.

Formulating oxime carbamates in liquid compositions offers advantages to end users, in particular when diluting the composition for application, for example by spraying on a locus. However, it has been found that the stability of oxime carbmates, such as oxamyl, in liquid formulations can be low. This instability reduces the effective amount of oxamyl available for treatment of the target plants. This in turn results either a reduced effectiveness of the composition or the need to increase the application rate of the composition.

As a result, it would be advantageous if a stable liquid formulation of oxime carbamates, such as oxamyl, could be provided, which formulation maintains a high effectiveness for the end user and which avoids the need for applying the formulation at' higher application rates. It would also be advantageous if the formulation could contain a high amount of the oxime carbamate active ingredient in solution, which in turn reduces the volume of the liquid concentrate formulation that is required to treat a locus at a given application rate of active ingredients.

### SUMMARY

Surprisingly, it has now been found that carboxylic acids, especially aliphatic carboxylic acids, are active in stabilising a liquid formulation, in particular a soluble liquid concentrate (SL) formulation, having a high concentration of an oxime carbamate. In particular, it has been found that including a carboxylic acid in the soluble liquid concentrate formulation significantly reduces or prevents the degradation of the oxime carbamate active ingredient. Such degradation can lead to a phenomenon known as packaging bottle flatulence, in which the shape of the bottle or container in which the formulation is being held can become deformed.

In a first aspect, the present invention provides the use of a carboxylic acid to stabilise a soluble liquid concentrate (SL) composition comprising:

i) an oxime carbamate; and

ii) a liquid carrier.

The present invention also provides a soluble liquid concentrate (SL) composition comprising:

i) an oxime carbamate;

ii) a carboxylic acid stabiliser; and

iii) a liquid carrier.

In the composition of the present invention, the carboxylic acid functions to stabilise the composition, in particular to maintain the oxime carbamate active ingredient in solution in the liquid carrier and prevent the oxime carbamate from precipitating out of solution. The action of the carboxylic acid is also to allow a higher concentration of the oxime carbamate to be maintained in solution.

The composition is a liquid soluble concentrate (SL) formulation. In use, the formulation is diluted with a liquid, most typically water, for application to a locus and/or plants to be treated, for example by spraying. An advantage of the composition of the present invention is that it is readily dispersed and dissolved in water, when diluted. This provides a significant advantage to end users in the field.

The composition comprises oxime carbamate as an active pesticidal component. It has been found that carboxylic acids are active in stabilising oxime carbonates in liquid concentrate formulations, in particular preventing the oxime carbonate from precipitating out of solution, in turn allowing higher concentrations of oxime carbonates to be employed.

Suitable oxime carbamates are known in the art and are commercially available. Examples of suitable oxime carbamates include alanycarb, aldicarb, aldoxycarb, butocarboxim, butoxycarboxim, methomyl, nitrilcarb, oxamyl, tazimcarb, thiocarboxime, thiodicarb and thiofanox. Preferred oxime carbamates for use in the present invention include oxamyl and methomyl. Oxamyl is a particularly preferred oxime carbamate.

The composition may comprise a single oxime carbamate. Alternatively, two or more oxime carbamates may be present in the composition.

The oxime carbamate is present in the composition in solution, dissolved in the liquid carrier. The oxime carbamate may be present in the composition in any suitable amount. The amount of the oxime carbamate may be limited by such factors as the solubility of the oxime carbamate in the liquid carrier, which in turn depends upon the liquid carrier employed.

The oxime carbamate may be present in the composition in an amount of up to 60% by weight, preferably up to 55%, more preferably up to 50%, still more preferably up to 45% by weight. Compositions having an oxime carbamate content of up to 50% by weight, preferably up to 45% are preferred. Compositions having a lower oxime carbamate content, such as up to 30% by weight, for example up to 25% by weight, are also particularly useful. The oxime carbamate may be present in the composition in an amount of at least 5% by weight, preferably at least 10%, more preferably at least 15%, still more preferably at least 20% by weight. Very suitable compositions may have an oxime carbamate present in an amount of from 5 to 60% by weight, preferably from 10 to 50% by weight, more preferably from 15 to 45% by weight.

The composition further comprises one or more carboxylic acids. The carboxylic acid may be a monocarboxylic acid or comprise a plurality of —COOH groups, for example the dicarboxylic acids. Monocarboxylic acids are particularly suitable. Suitable carboxylic acids have from 1 to 12 carbon atoms, preferably from 1 to 10 carbon atoms, more preferably from 1 to 8 carbon atoms, still more preferably from 1 to 6 carbon atoms, more preferably still from 1 to 4 carbon atoms. The carboxylic acids may be aliphatic, alicyclic or aromatic. Aliphatic carboxylic acids are particularly suitable and may be straight chain or branched. Examples of preferred monocarboxylic acids include formic acid, acetic acid, propionoic acid, butyric acid, valeric acid, caproic acid and benzoic acid. Examples of preferred dicarboxlylic acids include oxalic acid and malic acid. Higher carboxylic acids include tricarboxylic acids.

Particularly preferred organic acids are aliphatic acids, in particular aliphatic acids having from 1 to 6 carbon atoms, preferably from 1 to 4 carbon atoms, with acetic acid being especially preferred.

The carboxylic acid may be present in any amount sufficient to provide the necessary stability of the oxime carbamate active ingredient. The carboxylic acid may be present in an amount of from 0.1% by weight, preferably from 0.2%, still more preferably from 0.3%, more preferably still from 0.5% by weight. Compositions comprising carboxylic acid in an amount from 0.6% by weight, preferably from 0.7%, more preferably from 0.8%, still more preferably from 1.0% by weight are particularly effective. The carboxylic acid may be present in an amount of up to 10% by weight, preferably up to 8% by weight, more preferably up to 7%, still more preferably up to 6%, more preferably still up to 5% by weight. Carboxylic acid concentrations of from 0.3 to 7% by weight are preferred, more preferably from 0.4 to 6%, still more preferably from 0.5 to 5% by weight. In many embodiments, a carboxylic acid concentration of from 1 to 4% by weight has been found to be very suitable.

The composition of the present invention is acidic. Preferred pH values for the composition are up to 6.5, more preferably up to 6.0, still more preferably up to 5.5, more preferably still up to 5.0, especially up to 4.5, more especially up to 4.0. A pH of above 2.0 is preferred, more preferably above 2.5, still more preferably above 3.0. A pH in the range of from 2.0 to 6.0 is preferred, more preferably from 2.5 to 5.0, still more preferably from 3.0 to 4.0, more preferably still from 3.3 to 3.8. A pH of about 3.5 is particularly preferred for many applications.

It has been found that a pH of below 4 is particularly suitable for stabilising the oxime carbamate active ingredient in the composition. At higher pH values, the oxime carbamate may have a tendency to decompose. As noted above, this can lead to deformation of the container in which the composition is being held.

The composition of the present invention further includes a liquid carrier. The liquid carrier comprises a solvent system. The oxime carbamate active ingredient is soluble in the solvent system.

The composition may comprise the liquid carrier in an amount of up to 90% by weight, preferably up to 85%, more preferably up to 80% by weight. The composition may comprise the liquid carrier in an amount of from 30%, preferably from 35%, more preferably from 40%, still more preferably from 45% by weight. The liquid carrier may be present in an amount of from 30 to 90% by weight, preferably from 35 to 85%, more preferably from 40 to 80%, still more preferably from 45 to 75% by weight. In one embodiment, the liquid carrier is present in an amount of from 45 to 65% by weight, preferably from 50 to 60%, especially about 55% by weight. In a further embodiment, the liquid carrier is present in an amount of from 65 to 85% by weight, preferably from 70 to 80% by weight, especially about 75% by weight.

The solvent system may comprise an alcohol. Suitable alcohols for use in the solvent system include aliphatic, alicyclic and aromatic alcohols. Aliphatic and alicyclic alcohols may be saturated or have a degree of unsaturation. Saturated aliphatic and alicyclic alcohols are preferred. Aliphatic alcohols are preferred. The aliphatic alcohols may be straight chained or branched chained. Straight chained aliphatic alcohols are preferred for use in many embodiments.

The alcohol may be a monohydric alcohol or a polyhydric alcohol, having two or more hydroxyl groups. Monohydric alcohols are preferred.

The alcohol may have from 1 to 12 carbon atoms, preferably from 1 to 10, more preferably from 1 to 8 carbon atoms, still more preferably from 1 to 6 carbon atoms. Particularly preferred alcohols include methanol, ethanol, propanol, butanol, pentanol and hexanol. C1 to C4 alcohols are particularly preferred, especially methanol, ethanol and propanol. Methanol and ethanol are particularly suitable alcohols, with methanol being especially preferred.

The solvent system may comprise a single alcohol or a mixture of two or more alcohols.

The solvent system may comprise a carbonate ester. Suitable carbonate esters for use in the solvent system include dialkyl and diaryl carbonate esters, having a carbonate group with two R substituents, in which each R substituent is an alkyl group or an aryl group. Suitable carbonate esters also include carbonate esters in which two carbonate groups are linked by an aliphatic or aromatic bifunctional group. Preferably, the carbonate ester is one in which the carbonate groups are linked by a 2- or 3-carbon bridge, more preferably a 2-carbon bridge. Preferred carbonate esters have the following general formula:

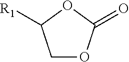

In the above formula, R1 may be selected from hydrogen or a lower alkyl group, preferably a C1 to C6 alkyl group, more preferably a C1 to C4 alkyl group, still more preferably an alkyl group having one, two or three carbon atoms, especially one or two carbon atoms. Propylene carbonate, that is a compound of the above formula in which R1 is methyl, is particularly preferred.

The solvent system may comprise a single carbonate ester or a mixture of two or more carbonate esters.

The solvent system may comprise water.

The solvent system may comprise a pyrrolidone, in particular a 2-pyrrolidone. The pyrrolidone is preferably substituted, more preferably N- substituted. Preferred substituents are alkyl groups, more preferably C1 to C4 alkyl groups, still more preferably methyl and ethyl, with methyl being particularly preferred. One particularly suitable pyrrolidone is N-methyl-pyrrolidone.

The solvent system may comprise a lactone, with gamma-butyrolactone being particularly preferred.

In a preferred embodiment, the solvent system comprises a combination comprises an alcohol, a carbonate ester and water.

In this preferred embodiment, the alcohol may be present in the composition in an amount of up to 65% by weight, preferably up to 60%, more preferably up to 55%, still more preferably up to 50% by weight. The alcohol may be present in the composition in an amount of from 3% by weight, preferably from 4% by weight, more preferably from 5% by weight. An alcohol content of from 3 to 65% is suitable for many embodiments, preferably from 4 to 60%, more preferably from 5 to 55%, still more preferably from 5 to 50% by weight. An alcohol content of from 18 to 22% by weight is particularly suitable for some embodiments, especially about 20% by weight of the composition. In other embodiments, an alcohol content of from 20 to 50% by weight is very suitable, for example about 40%.

The carbonate ester may be present in the composition of this embodiment in an amount of up to 65% by weight, preferably up to 60%, more preferably up to 55%, still more preferably up to 50% by weight. The carbonate ester may be present in the composition in an amount of from 2% by weight, preferably from 4% by weight, more preferably from 5% by weight. A carbonate ester content of from 2 to 65% is suitable for many embodiments, preferably from 3 to 60%, more preferably from 4 to 55%, still more preferably from 5 to 50% by weight. A carbonate ester content of from 6 to 18% by weight is particularly suitable for many embodiments, preferably from 7 to 17%, especially from 8 to 16% by weight of the composition. In one embodiment, a carbonate ester content of about 9% by weight is preferred. In another embodiment, a carbonate ester content of about 15% by weight is preferred. In other embodiments, carbonate ester contents of about 5, 15 35 and 50% by weight are particularly preferred.

The solvent system of this embodiment further comprises water. Water may be present in the composition in an amount of up to 75% by weight, preferably up to 70%, more preferably up to 65%, still more preferably up to 60% by weight. Water may be present in the composition in an amount of from 3% by weight, preferably from 4% by weight, more preferably from 5% by weight. A water content of from 3 to 75% is suitable for many embodiments, preferably from 4 to 70%, more preferably from 5 to 65%, still more preferably from 5 to 60% by weight. A water content of from 15 to 50% by weight is particularly suitable for many embodiments, preferably from 17 to 47%. In one embodiment, a water content of from 15 to 30%, preferably from 17 to 25%, especially about 20% by weight is preferred. In another embodiment, a water content of from 35 to 55%, preferably from 40 to 50%, especially about 45% by weight is preferred.

The three solvents may be present in the solvent system of this embodiment in any suitable amount and ratio. The relative amounts of the solvents may be selected by such factors as the amount of oxime carbamate to be dissolved.

The solvent system of this embodiment may comprise the alcohol in an amount of up to 75% by weight of the total solvent system present in the composition, preferably up to 70%, more preferably up to 65% by weight. The solvent system may comprise the alcohol in an amount of from 4% by weight of the total solvent system present in the composition, preferably from 5%, more preferably from 6% by weight. The alcohol may be present in the solvent system in an amount of from 4 to 75% by weight, preferably from 5 to 70%, more preferably from 6 to 65% by weight. In one embodiment, the alcohol is present in the solvent system in an amount of from 25 to 75% by weight, preferably from 30 to 70%, still more preferably from 35 to 60% by weight. In another embodiment, the alcohol is present in the solvent system in an amount of from 20 to 35% by weight, preferably from 20 to 30%, still more preferably from 25 to 30% by weight.

The solvent system of this embodiment may comprise the carbonate ester in an amount of up to 75% by weight of the total solvent system present in the composition, preferably up to 70%, more preferably up to 65% by weight. The solvent system may comprise the carbonate ester in an amount of from 4% by weight of the total solvent system present in the composition, preferably from 5%, more preferably from 6% by weight. The carbonate ester may be present in the solvent system in an amount of from 4 to 75% by weight, preferably from 5 to 70%, more preferably from 6 to 65% by weight. In one embodiment, the carbonate ester is present in the solvent system in an amount of from 15 to 35% by weight, preferably from 20 to 30%, still more preferably from 25 to 30% by weight. In another embodiment, the carbonate ester is present in the solvent system in an amount of from 5 to 25% by weight, preferably from 10 to 20%, still more preferably from 10 to 15% by weight.

The solvent system of this embodiment may comprise water in an amount of up to 90% by weight of the total solvent system present in the composition, preferably up to 85%, more preferably up to 80% by weight. The solvent system may comprise water in an amount of from 4% by weight of the total solvent system present in the composition, preferably from 5%, more preferably from 6% by weight. Water may be present in the solvent system in an amount of from 4 to 90% by weight, preferably from 5 to 85%, more preferably from 6 to 80% by weight.

In one embodiment, water is present in the solvent system in an amount of from 40 to 75% by weight, preferably from 50 to 70%, still more preferably from 55 to 65% by weight. In another embodiment, water is present in the solvent system in an amount of from 20 to 45% by weight, preferably from 25 to 40%, still more preferably from 30 to 40% by weight.

The solvent system may comprise the alcohol and the carbonate ester in a weight ratio of from 1:10 to 10:1. The solvent system may comprise the alcohol and water in a weight ratio of from 1:8 to 8:1. The solvent system may comprise the carbonate ester and water in a weight ratio of from 1:12 to 12:1.

The soluble concentrate (SL) composition may be formulated in ways known in the art and to the skilled person. The composition may further comprise one or more auxiliaries. Again, the inclusion and use of such auxiliaries are known in the art. In particular, the composition may further comprise one or more auxiliaries selected from surfactants, stabilizers, anti-foaming agents, anti-freezing agents, preservatives, antioxidants, and colorants. Such auxiliaries are known in the art and are commercially available. Their use in the formulation of the compositions of the present invention will be apparent to the person skilled in the art.

The composition may include one or more surfactants, which are preferably non-ionic, cationic and/or anionic in nature, and surfactant mixtures which have good emulsifying, dispersing and wetting properties, depending upon the active compound/compounds being formulated. Suitable surfactants are known in the art and are commercially available.

Suitable anionic surfactants can be both so-called water-soluble soaps and water-soluble synthetic surface-active compounds. Soaps which may be used include the alkali metal, alkaline earth metal or substituted or unsubstituted ammonium salts of higher fatty acids (C10 to C22), for example the sodium or potassium salt of oleic or stearic acid, or of natural fatty acid mixtures.

The surfactant may comprise an emulsifier, dispersant or wetting agent of ionic or nonionic type. Examples of such surfactants include salts of polyacrylic acids, salts of lignosulphonic acid, salts of phenylsulphonic or naphthalenesulphonic acids, polycondensates of ethylene oxide with fatty alcohols or with fatty acids or with fatty amines, substituted phenols, especially alkylphenols, sulphosuccinic ester salts, taurine derivatives, especially alkyltaurates, and phosphoric esters of polyethoxylated phenols or alcohols.

The composition optionally further comprises one or more polymeric stabilizers. Suitable polymeric stabilizers that may be used in the present invention include, but are not limited to, polypropylene, polyisobutylene, polyisoprene, copolymers of monoolefins and diolefins, polyacrylates, polystyrene, polyvinyl acetate, polyurethanes or polyamides. Suitable stabilizers are known in the art and commercially available.

The surfactants and polymeric stabilizers mentioned above are generally believed to impart stability to the composition, in turn allowing the composition to be formulated, stored, transported and applied.

Suitable anti-foaming agents include all substances which can normally be used for this purpose in agrochemical compositions. Suitable anti-foaming agents are known in the art and are available commercially. Particularly preferred anti-foaming agents are mixtures of polydimethylsiloxanes and perfluroalkylphosphonic acids, such as the silicone anti-foaming agents commercially available from GE or Compton.

Suitable preservatives for use in the composition of the present invention include all substances which can normally be used for this purpose in agrochemical compositions of this type and again are well known in the art. Suitable examples that may be mentioned include the commercially available preservatives PREVENTOL® (from Bayer AG) and PROXEL® (from Bayer AG).

Suitable antioxidants for use in the compositions of the present invention are all substances which can normally be used for this purpose in agrochemical compositions, as is known in the art. Preference is given to butylated hydroxytoluene.

The composition may further comprise one or more colouring agents or dyes. Suitable colouring agents and dyes are known in the art and are available commercially. One example of a suitable dye is tartrazine.

In a further aspect, the present invention provides a method for the treatment of pest infestations, in particular infestations of insects, acari and/or nematodes, at a locus, the method comprising applying to the locus a composition as hereinbefore described.

In a still further aspect, the present invention provides the use of a composition as hereinbefore described in the control of pest infestations, in particular infestations of insects, acari and/or nematodes, in plants.

The compositions employed in the practice of the present invention can be applied in a variety of ways known to those skilled in the art, at various concentrations. The method and compositions of the present invention are useful in controlling or preventing infestations of insects, acari and nematodes in plants, in particular crop plants, by applying the composition to plant materials, such as plants, plant parts and seeds, and/or the locus pre-planting, pre-emergence and/or post-emergence. The composition may be applied to the locus and/or plant materials by conventional methods including coating, spraying, sprinkling, dipping, soaking, injection, irrigation, and the like.

In general, the liquid soluble concentrate (SL) composition of the present invention is diluted with a liquid carrier, most particularly water, before being applied as hereinbefore described.

The composition may be applied to a locus to be treated in any suitable amount to obtain the desired control of pests. Typically, the composition is applied to a locus or plants to be treated in an amount to provide an application rate of the active oxime carbonate ingredient of from 300 to 5000 g/ha, preferably from 500 to 4500 g/ha.

In the method and use of the present invention, the composition can be applied to the locus where control is desired, such as to the leaves of plants and/or the surrounding soil, by a convenient method. The term “locus” refers to the place where the plants are growing, the place where the plant propagation materials of the plants are sown or the place where the plant propagation materials of the plants will be sown.

The composition and method of the present invention may employ other pesticides, in addition to one or more oxime carbamates. For example, compositions of the present invention may contain or be mixed with other pesticides, such as herbicides, fungicides, insecticides and nematicides, growth factor enhancers and fertilizers, to enhance the activity of the present invention or to widen its spectrum of activity. Similarly, the method of the present invention may be employed in conjunction with the use of one or more of the aforementioned active ingredients, again to obtain an enhanced efficacy or broader spectrum of activity.

The liquid compositions of the present invention are typically stored and transported packaged in bottles, most typically plastic bottles. It is important that the integrity of the bottle is maintained, to prevent spillage of the composition occurring. In addition to the effects of the carboxylic acid on stabilising the oxime carbamate active ingredients and reducing or preventing decomposition of the oxime carbamate, it has also been found that the presence of certain carboxylic acids can reduce or eliminate the effect of so-called ‘packaging bottle flatulence’.

The effect of packaging bottle flatulence manifests itself in the bottles in which the composition is stored expanding, becoming misshapen and bloated. It has been found that the presence of a carboxylic acid in the composition can reduce the occurrence of packaging bottle flatulence. In particular, it has been found that acetic acid is particularly effective in this respect.

Accordingly, in a further aspect, the present invention provides the use of a carboxylic acid to prevent packaging bottle flatulence occurring in a bottle containing a soluble liquid concentrate (SL) composition comprising:

i) an oxime carbamate; and

ii) a liquid carrier.

As noted above, the carboxylic acid may be a monocarboxylic acid or comprise a plurality of —COOH groups, for example the dicarboxylic acids. Suitable carboxylic acids have from 1 to 12 carbon atoms, preferably from 1 to 10 carbon atoms, more preferably from 1 to 8 carbon atoms. The carboxylic acids may be aliphatic, alicyclic or aromatic. Aliphatic carboxylic acids may be straight chain or branched. Examples of preferred monocarboxylic acids include formic acid, acetic acid, propionoic acid, butyric acid, valeric acid, caproic acid and benzoic acid. Examples of preferred dicarboxlylic acids include oxalic acid and malic acid. Higher carboxylic acids include tricarboxylic acids, such as citric acid.

Particularly preferred organic acids are alphatic acids, in particular aliphatic acids having from 1 to 6 carbon atoms, preferably from 1 to 4 carbon atoms, with acetic acid being especially preferred.

Other details of the composition are as discussed above.

Although the invention has been described with reference to preferred embodiments and examples thereof, the scope of the present invention is not limited only to those described embodiments. As will be apparent to persons skilled in the art, modifications and adaptations to the above-described invention can be made without departing from the spirit and scope of the invention, which is defined by the appended claims.

Embodiments of the present invention will now be described, for illustrative purposes only, by way of the following examples.

Percentage figures are percent by weight, unless otherwise indicated.

### DETAILED DESCRIPTION

### EXAMPLES

### Example 1

A soluble concentrate (SL) formulation was prepared by mixing the following components:

| | |
|---|---|
| Oxamyl (97.5% TG) | 43.0% |
| Methanol | 20.0% |
| Propylene carbonate | 15.0% |
| Acetic acid | 1.0% |
| Brilliant blue FCF (Dye) | 0.002% |
| Tartrazine (Dye) | 0.0002% |
| Water | to 100% |

The formulation had a pH of about 3.5. The formulation exhibited excellent stability.

### Example 2

A soluble concentrate (SL) formulation was prepared by mixing the following components:

| | |
|---|---|
| Oxamyl (97.5% TG) | 24.6% |
| Methanol | 20.0% |
| Propylene carbonate | 9.0% |
| Acetic acid | 1.0% |
| Brilliant blue FCF (Dye) | 0.03% |
| Tartrazine (Dye) | 0.07% |
| Water | to 100% |

The formulation had a pH of about 3.5. The formulation exhibited excellent stability.

### Field Test Examples

The compositions of Examples 1 and 2 were dispersed in water to form a diluted spray medium. The spray medium was sprayed on plants at a locus.

The compositions of Examples 1 and 2 were readily compatible with water and easily dispersed in water to form the spray medium. The spray medium was readily sprayed using standard spray equipment with no indication of any instability of the active components of the composition, which remained in solution.

### Stability Test 1

Soluble liquid (SL) formulations 3 to 7 and Comparative formulation A were prepared as described above having the compositions summarised in Table 1 below.

TABLE 1

| | Comparative | | | | | |
|---|---|---|---|---|---|---|
| | Example | Example | Example | Example | Example | Example |
| Component | A | 3 | 4 | 5 | 6 | 7 |
| Oxamyl (%) | 24 | 24 | 24 | 24 | 24 | 24 |
| Boric Acid (%) | — | 1 | — | — | — | — |
| Acetic Acid (%) | — | | 1 | — | — | — |
| Citric Acid (%) | — | — | — | 1 | — | — |
| Phosphoric Acid (%) | — | — | — | — | 1 | — |
| Hydrochloric Acid (%) | — | — | — | — | — | 1 |
| Methanol (%) | 40 | 40 | 40 | 40 | 40 | 40 |
| Propylene Carbamate (%) | 10 | 10 | 10 | 10 | 10 | 10 |
| Water (%) | 25 | 25 | 25 | 25 | 25 | 25 |

Samples of the compositions summarised in Table 1 above were packaged in commercially available 500 ml fluorinated plastic bottles and the bottles sealed. The bottles were stored at 54° C. for 14 days. Thereafter, the bottles were cooled to room temperature and their appearance assessed. The concentration of the active ingredient, oxamyl, in each bottle was measured.

The results are set out in Table 2 below.

TABLE 2

| | | Oxamyl | | |
|---|---|---|---|---|
| | | content after | | Observed |
| | | storage at | Degradation | packaging |
| | | 54° C. | of oxamyl | bottle |
| | pH | (%) | (%) | flatulence |
| Comparative | 6.63 | 18.8 | 21.7 | Serious |
| Example A | | | | |
| Example 3 | 6.52 | 18.5 | 22.6 | Serious |
| Example 4 | 3.67 | 23.5 | 2.08 | None |
| Example 5 | 3.55 | 23.6 | 2.07 | Medium |
| Example 6 | 3.50 | 23.4 | 2.09 | Medium |
| Example 7 | 3.40 | 23.4 | 2.50 | Medium |

From the results set out in Table 2 above, it can be seen that boric acid was not effective in stabilising the oxamyl active ingredient and did not prevent packaging bottle flatulence. The presence of citric acid, phosphoric acid and hydrochloric acid in the compositions significantly reduced the chemical degradation of the oxamyl active ingredient. However, the compositions containing these acids exhibited packaging bottle flatulence, as evidenced by observed deformation of the bottle. Acetic acid present in the composition significantly reduced the chemical degradation of oxamyl and also eliminated all observable packaging bottle flatulence.

### Stability Test 2

Soluble liquid (SL) formulations 8 to 15 were prepared as described above having the compositions summarised in Table 3 below.

TABLE 3

| | Example | Example | Example | Example | Example | Example | Example | Example |
|---|---|---|---|---|---|---|---|---|
| | 8 | 9 | 10 | 11 | 12 | 13 | 14 | 15 |
| Oxamyl (%) | 24 | 24 | 24 | 24 | 24 | 24 | 24 | 24 |
| Acetic Acid (%) | 1 | 1 | 1 | 1 | 1 | 1 | 2 | 3 |
| Methanol (%) | 50 | 10 | 50 | 10 | 5 | 35 | 15 | 15 |
| Propylene Carbonate (%) | 5 | 5 | 15 | 15 | 35 | 35 | 15 | 15 |
| Water (%) | 20 | 60 | 10 | 50 | 35 | 5 | 9 | 8 |

Samples of the compositions summarised in Table 3 above were packaged in commercially available 500 ml fluorinated plastic bottles and the bottles sealed. The bottles were stored at 54° C. for 14 days. Thereafter, the bottles were cooled to room temperature and their appearance assessed. The concentration of the active ingredient, oxamyl, in each bottle was measured.

The results are set out in Table 4 below.

TABLE 4

| | | Oxamyl | | |
|---|---|---|---|---|
| | | content after | | Observed |
| | | storage at | Degradation | packaging |
| | | 54° C. | of oxamyl | bottle |
| | pH | (%) | (%) | flatulence |
| Example 8 | 3.65 | 23.8 | 1.24 | None |
| Example 9 | 3.69 | 23.2 | 2.11 | None |
| Example 10 | 3.65 | 24.0 | 1.64 | None |
| Example 11 | 3.66 | 23.4 | 1.69 | None |
| Example 12 | 3.63 | 23.8 | 2.06 | None |
| Example 13 | 3.62 | 23.5 | 1.67 | None |
| Example 14 | 3.43 | 23.9 | 1.24 | None |
| Example 15 | 3.20 | 23.6 | 2.07 | None |

From the data set out in Table 4, it can be seen that the compositions comprising acetic acid exhibited a very high level of stability of the oxamyl active ingredient. In addition, the presence of acetic acid prevented the occurrence of packaging bottle flatulence.

1. A soluble liquid concentrate (SL) composition comprising:
i) an oxime carbamate;
ii) a carboxylic acid stabiliser; and
iii) a liquid carrier.

2. The composition according to claim 1, where the composition comprises a single oxime carbamate.

3. The composition according to claim 1, wherein the oxime carbamate is selected from alanycarb, aldicarb, aldoxycarb, butocarboxim, butoxycarboxim, methomyl, nitrilcarb, oxamyl, tazimcarb, thiocarboxime, thiodicarb, thiofanox and mixtures thereof.

4. The composition according to claim 3, wherein the oxime carbamate is selected from oxamyl, methomyl and mixtures thereof

5. The composition according to claim 4, wherein the oxime carbamate comprises oxamyl.

6. The composition according to claim 1, wherein the oxime carbamate is present in an amount of up to 60% by weight.

7. The composition according to claim 6, wherein the oxime carbamate is present in an amount of up to 45% by weight.

8. The composition according to claim 1, wherein the oxime carbamate is present in an amount of at least 5% by weight.

9. The composition according to claim 8, wherein the oxime carbamate is present in an amount of at least 20% by weight.

10. The composition according to claim 1, wherein the carboxylic acid is an aliphatic carboxylic acid.

11. The composition according to claim 1, wherein the carboxylic acid has from 1 to 8 carbon atoms.

12. The composition according to claim 11, wherein the carboxylic acid is selected from formic acid, acetic acid, propionoic acid, butyric acid, valeric acid, caproic acid and benzoic acid.

13. The composition according to claim 12, wherein the carboxylic acid is acetic acid.

14. The composition according to any preceding claim claim 1, wherein the composition has a pH of up to 6.5.

15. The composition according to claim 14, wherein the composition has a pH of up to 4.0.

16. The composition according to claim 15, wherein the composition has a pH of from 3.0 to 4.0.

17. The composition according to claim 1, wherein the carboxylic acid is present in an amount of from 0.5 to 5% by weight.

18. The composition according to claim 1, wherein the liquid carrier is present in an amount of up to 80% by weight of the composition.

19. The composition according to claim 1, wherein the liquid carrier is present in an amount of from 40% by weight of the composition.

20. The composition according to claim 1, wherein the liquid carrier is present in an amount of from 65 to 85% by weight of the composition.

21. The composition according to claim 1, wherein the liquid carrier comprises an alcohol.

22. The composition according to claim 21, wherein the alcohol is a monohydric alcohol.

23. The composition according to claim 21, wherein the alcohol has from 1 to 8 carbon atoms.

24. The composition according to claim 23, wherein the alcohol is selected from methanol, ethanol, propanol, butanol, pentanol and hexanol.

25. The composition according to claim 21, wherein the liquid carrier comprises methanol or ethanol.

26. The composition according to claim 20, wherein the alcohol is present in the composition in an amount of up to 50% by weight.

27. The composition according to claim 26, wherein the alcohol is present in the composition in an amount of from 5% by weight.

28. The composition according to claim 1, wherein the liquid carrier comprises a carbonate ester.

29. The composition according to claim 28, wherein the carbonate ester has the general formula: 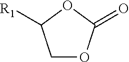
in which R1 is selected from hydrogen or a lower alkyl group.

30. The composition according to claim 29, wherein R1 is methyl.

31. The composition according to claim 28, wherein the carbonate ester is present in the composition in an amount of up to 50% by weight.

32. The composition according to claim 28, wherein the carbonate ester is present in the composition in an amount of from 5% by weight.

33. The composition according to claim 1, wherein the liquid carrier comprises water.

34. (Originally Filed) The composition according to claim 33, wherein water is present in the composition in an amount of up to 60% by weight.

35. The composition according to claim 33, wherein water is present in the composition in an amount of from 5% by weight.

36. The composition according to claim 1, wherein the liquid carrier comprises an alcohol and a carbonate ester in a weight ratio of from 1:10 to 10:1.

37. The composition according to claim 1, wherein the liquid carrier comprises an alcohol and water in a weight ratio of from 1:8 to 8:1.

38. The composition according to claim 1, wherein the liquid carrier comprises a carbonate ester and water in a weight ratio of from 1:12 to 12:1.

39. The composition according to claim 1, further comprising one or more auxiliaries selected from surfactants, stabilizers, anti-foaming agents, anti-freezing agents, preservatives, antioxidants, and colorants.

40. A method for the treatment of pest infestations at a locus, the method comprising applying to the locus a composition according to claim 1.

41. The use of a composition according to claim 1 in the treatment of pest infestations.

42. The use of a carboxylic acid to stabilise a soluble liquid concentrate (SL) composition comprising:
i) an oxime carbamate; and
ii) a liquid carrier.

43. The use according to claim 42, wherein the carboxylic acid is an aliphatic carboxylic acid.

44. The use according to claim 42, wherein the carboxylic acid has from 1 to 8 carbon atoms.

45. The use according to claim 44, wherein the carboxylic acid is selected from formic acid, acetic acid, propionoic acid, butyric acid, valeric acid, caproic acid and benzoic acid.

46. The use according to claim 45, wherein the carboxylic acid is acetic acid.

47. The use according to claim 1, wherein the carboxylic acid is present in the composition in an amount to provide a pH of up to 6.5.

48. The use according to claim 47, wherein the composition has a pH of up to 4.0.

49. The use according to claim 48, wherein the composition has a pH of from 3.0 to 4.0.

50. The use according to claim 1, wherein the carboxylic acid is present in the composition an amount of from 0.5 to 5% by weight.
